(19) United States
(12) Patent Application Publication
(10) Pub. No.: US 2002/0094419 A1
(43) Pub. Date: Jul. 18, 2002

(54) Method for fabricating microlens in batch and product manufactured the same

(76) Inventors: Yuh-Sheng Lin, Hsinchu City (TW); Kun-Lung Lin, Changhwa Hsien (TW); Cheng-Tang Pan, Tainan Hsien (TW); Shih-Chou Chen, Hsinchu City (TW); Jauh-Jung Yang, Taipei (TW)

Correspondence Address: RABIN & CHAMPAGNE, PC, 1101 14TH STREET, NW, SUITE 500, WASHINGTON, DC, 20005, US

(21) Appl. No.: 09/758,233

(22) Filed: Jan. 12, 2001

(51) Int. Cl. B32B 3/00

(52) U.S. Cl. 428/195

(57) ABSTRACT

A simple method for fabricating three-dimensional microlens in batch is disclosed. The method for fabricating three-dimensional microlens includes (A) providing a substrate; (B) coating a layer of first polymer or compositions comprising first polymer on said substrate; (C) coating a layer of second polymer or compositions comprising second polymer on said layer of first polymer; (D) forming patterns of said layer of second polymer or compositions comprising second polymer; (E) heating said substrate coated with said polymers to a temperature ranging from said glass transition temperature (Tg) of second polymer to said glass transition temperature (Tg) of first polymer; (F) maintaining said coated substrate at said temperature to form microlens; and (G) cooling said microlens.

### BACKGROUND OF THE INVENTION

1. Field of the Invention

The present invention relates to a method for fabricating microlens and the microlens thereby, more particularly, to a method for fabricating microlens in batch and the microlens thereby.

2. Description of Related Art

The microlens is widely applied in the optical communication, optoelectronics such as devices for focusing light signals at the end of optical fibers, focus of optical scanning, arrays of microlens and interconnects on optical integrated circuits. Several methods fro fabricating micorlens were disclosed before. For example, by using laser absorption and fiber tip melting on transparent media, microlens can form at the end of fibers and function as devices for light focusing. In addition, microlens are also made by immersing melting tips of optical fibers in a transparent medium and then cutting the tip by arc discharge. These processes for fabricating the microlens are very complicated and time-consuming. Besides, the machines for these fabrication processes are expensive, complicate and inconvenient to operate. In addition, microlens made through these methods only focus lights vertical to the plane of the ends of optical fibers or lights perpendicular to the plane of integrated optical circuits. In other words, microlens made through prior arts can only focus lights perpendicular to the plane of integrated optical circuits or the end plane of optical fibers. However, owing to rapid development of optical integrated circuits, microlens being able to focus light parallel to the plane of optical integrated circuits are in demand recently. To meet this demand, several microlens that can focus light parallel to the plane of optical integrated circuits are disclosed. For example, Micro-machined three-dimensional microlens for integrated optical system was proposed in 1994 (L. Y. Lin, S. S. Lee, K. S. J. Pister, and M. C. Wu,” micro-machined three-dimensional micro-optics for integrated optical system”, IEEE photonics technology letters, vol. 6, no. 12, December, 1994). The micro-machined three-dimensional microlens are formed by RIE and then assembled by rotating the microlens to stand on the plane of substrate. The microlens are required to be assembled by well-trained engineers carefully. The fabricating process of these microlens is complicate and the assembling of the microlens is inconvenient, expensive and time-consuming. On the other hand, microlens fixed on v-grooves on substrates through careful assembling are also suggested. The microlens fabricated through above methods can focus lights in a direction parallel to the plane of substrate. However, the methods mentioned above cannot be applied to produce microlens for focusing light horizontally in batch.

Therefore, it is desirable to provide a method for fabricating microlens being able to focus lights in a direction parallel to the plane of substrate to obviate the aforementioned problems.

### SUMMARY OF THE INVENTION

The object of the present invention is to provide a simple method for fabricating three-dimensional microlens in batch.

Another object of the present invention is to provide a simple method for mass-producing three-dimensional microlens through cheaper apparatus and simple processes.

Another object of the present invention is to provide a three-dimensional microlens that can focus light in a non-vertical direction.

To achieve the object, the method of the present invention includes (A) providing a substrate; (B) coating a layer of first polymer or compositions comprising first polymer on said substrate; (C) coating a layer of second polymer or compositions comprising second polymer on said layer of first polymer or compositions comprising first polymer; wherein the glass transition temperature (Tg) of first polymer is higher than the glass transition temperature (Tg) of second polymer; (D) forming patterns of said layer of second polymer or compositions comprising second polymer and layer of first polymer or compositions comprising first polymer through lithography, wherein said pattern of layer of second polymer or compositions comprising second polymer is as same as said pattern of layer of first polymer or compositions comprising first polymer; (E) heating said substrate coated with said polymers to a temperature ranging from said glass transition temperature (Tg) of second polymer to said glass transition temperature (Tg) of first polymer to reflow said second polymer; (F) maintaining said coated substrate at said temperature till said layer of second polymer or said composition comprising second polymer forms microlens; and (G) cooling said microlens.

The microlen of the present invention, comprising a substrate; a base on said substrate, wherein said base is produced through heating a layer of first polymer or composition comprising first polymer; and a len in ball shape on said base, wherein said len is produced by heating a layer of second polymer or composition comprising second polymer coated on said layer of first polymer or composition comprising first polymer at a temperature ranging from the glass transition temperature of second polymer to the glass transition temperature of first polymer to reflow said polymers.

The glass transition temperature (Tg) of second polymers of the present invention is not limited. Preferably, the glass transition temperature (Tg) of the second polymers of the present invention ranges from 100° C. to 350° C. On the other hand, any polymer with glass transition temperature (Tg) higher than the glass transition temperature (Tg) of the second polymers of the present invention can be proper first polymer. Preferably, the first polymer of the present invention is polyimide or polyamide. Polymers with high transparency and glass transition temperature (Tg) lower than the first polymer of the present invention can be second polymer of the present invention. Preferably, the second polymer function as a photoresist. Most preferably, the second polymer is polymethacrylate. The shape of the microlens is not limited. Preferably, the microlens of the present invention are in ball shape. The shape of the base of the microlens of the present invention is not limited. Preferably, the base of the microlens of the present invention is a circle or an ellipse. The shape of the pattern of the second polymer on the substrate is not limited. Preferably, the pattern of the second polymer is circle. The ratio of the depth of said second polymer to the width of said second polymer is not limited. Preferably, the ratio of the depth of said second polymer to the width of said second polymer is greater than or equal to 0.6.

The coating of the first polymer or the second polymer of the present invention can be performed through any conventional ways. Preferably, the coating of the first polymer or the second polymer of the present invention is achieved by spin coating. After the first polymer of the present invention is coated on the substrate, the substrate can be selectively prebaked through conventional ways. Similarly, the substrate can be selectively prebaked through conventional ways after the second polymer of the present invention is coated on the substrate. The stack of first polymers and second polymer of the present invention can further form same patterns through conventional photolithography. The formed patterns can be selectively post-baked after the patterned are developed if it's needed. After the patterns of first polymers and second polymers of the present invention are formed, the whole substrate is heated to a temperature ranging from the glass transition temperature of the second polymers to the glass transition temperature of the first polymers. The second polymers of the present invention will be softened and the viscosity of second polymers decreases as the temperature is above the glass transition temperature of the second polymers. The fluidity of the second polymers are considered further increases and the layer of the second polymer begins to reflow. The surface of the second polymers of the present invention maintains in a curve surface as the second polymers reflows. Furthermore, owing to the balance tensions between several interfaces, the layer of the second polymers of the present invention keeps in a symmetrical shape (e.g. hemisphere or mushroom shape). The shape of the second polymers depends on the ratio of the depth of said second polymer to the width of said second polymer. As the ratio of the depth of said second polymer to the width of said second polymer is greater than or equal to 0.6, the shape of the layer of the second flow of the present invention become in a ball-like shape.

As the temperature increases to a temperature higher than the lass transition temperature of the second polymers, the viscosity of first polymer of the present invention decreases and the fluidity of the first polymer increases. However, although the first polymer also reflows, the shape of the first polymer doesn't change a lot. The surface of the first polymer changes into curve surface and forms bases for the lens forming on the base.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the process for fabricating microlens of the present invention.

FIG. 2 is a cross-section view of the microlens of the [resent invention.

### DETAILED DESCRIPTION OF THE PREFERRED EMBODIMENT

The present invention is demonstrated in more detail with reference to the following examples, which are only illustrative and are not intended to limit the scope of the present invention.

### EXAMPLE 1

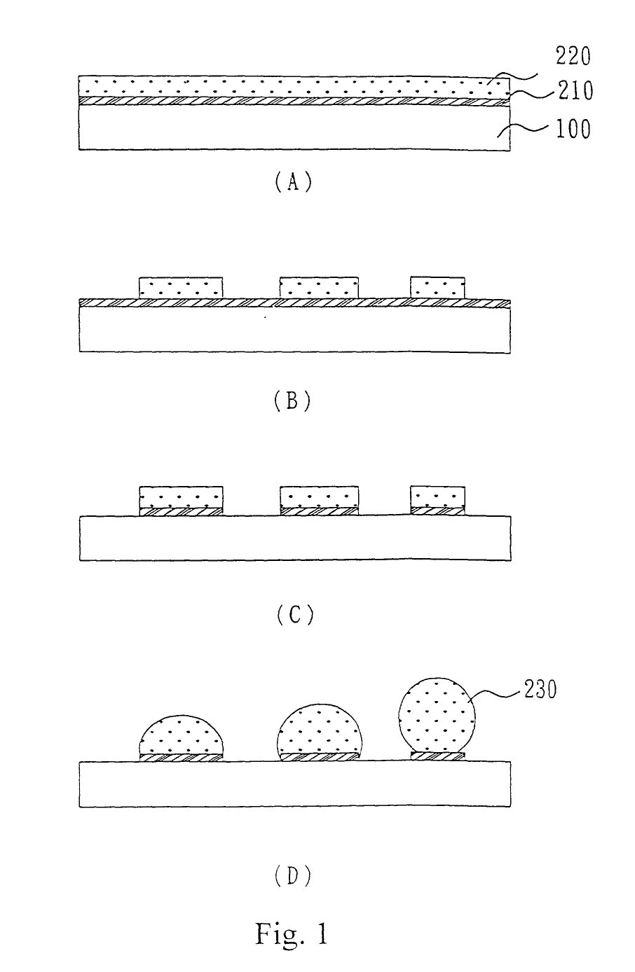

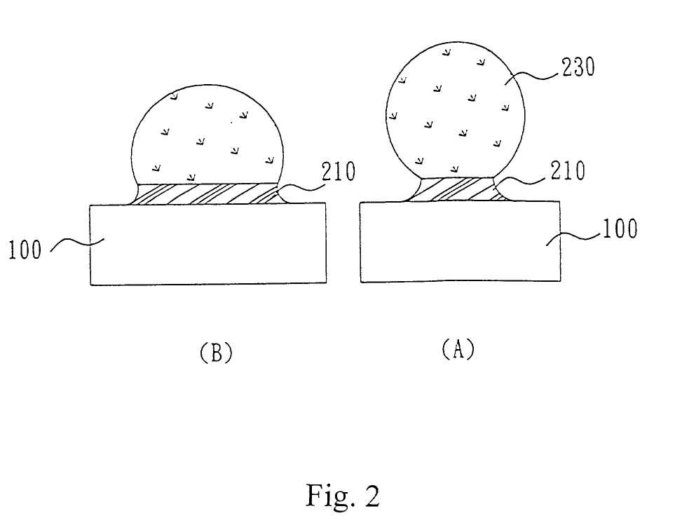

With reference to FIG. 1, there is shown that a layer of polyimide 210 with 30 μm thickness is coated on a substrate 100 through spin coating. The coated substrate is prebaked at 150° C. for 30 minutes. Then a layer of polyacrylate 220 is coated on the surface of the polyimide 210 on the substrate through spin coating (see FIG. 1A). The substrate with coated layers is processed through lithography to form patterns. The patterns of the first polymer and the second polymer are both in circle (or cylinder) shape. The width (or the diameter) of the top layer (the second polymer layer) is 30 μm and the thickness of the top layer (the second polymer layer) is 50 μm. Then the coated substrate is heated to 190° C. (or to a temperature ranging from 180° C. to 220° C.) to reflow the layer of second polymer. The temperature is kept at 190° C. till the microlens with curve surface form (about 12 hours, see FIG. 1(D)). In the meanwhile, the layer of the polyimide 210, i.e. the bottom layer, also reflows to form a base with curve surface. The viscosity of the polyacrylate or polyimide decreases as the temperature rises to 190° C. A microlens with curve surface and ball shape (see FIG. 2(B)) forms on the layer of polyacrylate because of the balance between the tensions of interfaces.

### EXAMPLE 2

The process for fabricatimg microlens is as same as that in example 1 except the width of the pattern of polyacrylate is replaced by 70 μm. After heating to reflow, the coated polyacrylate 220 on the substrate form a microlen in a mushroom shape (see FIG. 2A). The microlen in mushroom shape can be applied to focus light vertically.

Since the method for fabricating microlens in batch of the present invention use only heating and photolithography, the process is much simpler than the prior arts. In addition, the positions of the microlens of the present invention can be easily and accurately set or fixed through photolithography. Therefore, cost for well-trained labor for assembly can be reduced greatly. Furthermore, microlens can be mass-produced in batch through the method of the present invention. The time for producing microlens can be saved greatly. Since the position of the microlens fabricated through the method of the present invention can be accurately controlled, the microlens of the present invention can be integrated with v-groove technology for the use in microoptics. Since the microlens of the present invention can tfocus the light either horizontally or vertically, the microlens of the present invention can be used on a substrate and coupled with optical fiber for fiber optic coupling use. The microlens of the present invention can focus light either horizontally or vertically. The shape of the microlens of the present invention can be controlled easily by controlling the ratio of the width and thickness of the layer of the second polymer. Compare with the microlens made through other prior arts, the microlens of the present invention is simple, easy to make. Most important of all, the microlens of the present invention real 3-D microlens which can focus light horizontally and vertically.

Although the present invention has been explained in relation to its preferred embodiment, it is to be understood that many other possible modifications and variations can be made without departing from the spirit and scope of the invention as hereinafter claimed.

What is claimed is:

1. A process for manufacturing microlens in batch comprising following steps:
(A) providing a substrate;
(B) coating a layer of first polymer or compositions comprising first polymer on said substrate;
(C) coating a layer of second polymer or compositions comprising second polymer on said layer of first polymer or compositions comprising first polymer; wherein the glass transition temperature (Tg) of first polymer is higher than the glass transition temperature (Tg) of second polymer
(D) forming patterns of said layer of second polymer or compositions comprising second polymer and layer of first polymer or compositions comprising first polymer through lithography, wherein said pattern of layer of second polymer or compositions comprising second polymer is as same as said pattern of layer of first polymer or compositions comprising first polymer;
(E) heating said substrate coated with said polymers to a temperature ranging from said glass transition temperature (Tg) of second polymer to said glass transition temperature (Tg) of first polymer to reflow said second polymer;
(F) maintaining said coated substrate at said temperature till said layer of second polymer or said composition comprising second polymer forms microlens; and
(G) cooling said microlens.

2. The process according to claim 1, wherein said first polymer is polyimide.

3. The process according to claim 1, wherein said composition comprising second polymer is a photoresist composition.

4. The process according to claim 1, wherein said second polymer is polymethacrylate.

5. The process according to claim 1, wherein said pattern of said second polymer is circle.

6. The process according to claim 1, wherein the ratio of the depth of said second polymer to the width of said second polymer is greater than or equal to 0.6.

7. A microlen, comprising:
a substrate;
a base on said substrate, wherein said base is produced through heating a layer of first polymer or composition comprising first polymer; and
a len in ball shape on said base, wherein said len is produced by heating a layer of second polymer or composition comprising second polymer coated on said layer of first polymer or composition comprising first polymer at a temperature ranging from the glass transition temperature of second polymer to the glass transition temperature of first polymer to reflow said polymers.

8. The microlen according to claim 7, wherein said first polymer is polyimide.

9. The microlen according to claim 7, wherein said composition comprising first polymer is photoresist composition.

10. The microlen according to claim 7, wherein said second polymer is polyacrylate or polymethacrylate.
